(19) United States
(12) Patent Application Publication
(10) Pub. No.: US 2024/0323023 A1
(43) Pub. Date: Sep. 26, 2024

(54) SAMPLE ALIGNMENT METHOD AND APPARATUS, DEVICE, AND STORAGE MEDIUM

(71) Applicant: CHINA UNIONPAY CO., LTD., Shanghai (CN)

(72) Inventors: Yongkai ZHOU, Shanghai (CN); Yanming YANG, Shanghai (CN); Hongbao LIU, Shanghai (CN); Jianbin ZHENG, Shanghai (CN); Yang YANG, Shanghai (CN); Zhenyao QIU, Shanghai (CN); Chen OUYANG, Shanghai (CN); Ling JIN, Shanghai (CN); Pengfei GAO, Shanghai (CN); Dong CHENG, Shanghai (CN); Fen ZOU, Shanghai (CN); Hang YUAN, Shanghai (CN); Qi WANG, Shanghai (CN)

(21) Appl. No.: 18/579,216

(22) PCT Filed: Jul. 20, 2022
(86) PCT No.: PCT/CN2022/106819

§ 371 Date: Jan. 12, 2024

(30) Foreign Application Priority Data
Nov. 24, 2021 (CN) 202111399429.9

(51) Int. Cl. H04L 9/32; G06F 21/60

(52) U.S. Cl. CPC H04L 9/3234; G06F 21/602

(57) ABSTRACT

A method for sample alignment is applied to a first participant system, where a first trusted execution environment is deployed at the first participant system. The method includes, in the first trusted execution environment, obtaining at least one first sample identifier of the first participant system; through the first trusted execution environment, obtaining at least one second sample identifier of the second participant system from the second trusted execution environment, where the second trusted execution environment is deployed at the second participant system; in the first trusted execution environment, determining the first initial intersection of the at least one first sample identifier and the at least one second sample identifier and performing the shuffle processing on all first target sample identifiers in the first initial intersection to obtain the first target intersection; and based on the first target intersection, determining the first sample alignment result.

### CROSS-REFERENCE TO RELATED APPLICATIONS

This application claims priority of Chinese Patent Application No. 202111399429.9, entitled “Method, Apparatus, Device, and Storage Medium for Sample Alignment”, filed with the State Intellectual Property Office of P. R. China on Nov. 24, 2021, the entire content of which is incorporated herein by reference.

### FIELD OF THE DISCLOSURE

The present disclosure generally relates to the technical field of data processing and, more particularly, relates to a method, an apparatus, a device, and a storage medium for sample alignment.

### BACKGROUND

In the era of big data, when different participants engage in multi-participant cooperation, sample alignment operation is first performed, that is, the intersection of the sample IDs (Identity Document) of all participants is determined to facilitate subsequent model training or processing. However, each participant pays more attention to the protection of data privacy. Therefore, when performing sample alignment, participants ensure that the intersection of the sample IDs of all participants is obtained without revealing the sample IDs of the participants.

In the existing technology, a hardware encryption machine is used to encrypt the sample ID, and sample alignment operation is performed based on the encrypted sample ID. However, the hardware encryption machine is not sufficiently flexible and needs to be customized for different application scenarios, so that versatility of the hardware encryption machine is not high.

### BRIEF SUMMARY OF THE DISCLOSURE

Embodiments of the present disclosure provide a method, an apparatus, a device and a storage medium for sample alignment, configured to improve versatility of sample alignment in different application scenarios.

One aspect of embodiments of the present disclosure provides a method for sample alignment, applied to a first participant system where a first trusted execution environment is deployed at the first participant system. The method includes:
in the first trusted execution environment, obtaining at least one first sample identifier of the first participant system;
through the first trusted execution environment, obtaining at least one second sample identifier of the second participant system from a second trusted execution environment, where the second trusted execution environment is deployed at the second participant system;
in the first trusted execution environment, determining a first initial intersection of the at least one first sample identifier and the at least one second sample identifier, and performing a shuffle processing on all first target sample identifiers in the first initial intersection to obtain a first target intersection; and
based on the first target intersection, determining a first sample alignment result.

Another aspect of embodiments of the present disclosure provides an apparatus for sample alignment, where a first trusted execution environment is deployed at the apparatus for sample alignment. The apparatus includes:
an obtaining module, configured to, in the first trusted execution environment, obtain at least one first sample identifier of the first participant system; and through the first trusted execution environment, obtain at least one second sample identifier of the second participant system from a second trusted execution environment, where the second trusted execution environment is deployed at the second participant system; and
a sample alignment module, configured to, in the first trusted execution environment, determine a first initial intersection of the at least one first sample identifier and the at least one second sample identifier and perform a shuffle processing on all first target sample identifiers in the first initial intersection to obtain a first target intersection; and based on the first target intersection, determine a first sample alignment result.

Optionally, the at least one first sample identifier is obtained in the first trusted execution environment by the first participant system through encrypting a first original sample identifier using an encryption algorithm; and
the at least one second sample identifier is obtained in the second trusted execution environment by the second participant system through encrypting a second original sample identifier using the encryption algorithm.

Optionally, the apparatus further includes a verification module. The verification module is specifically configured to, in the first trusted execution environment, before obtaining the at least one first sample identifier of the first participant system, verify security of the second trusted execution environment through the first trusted execution environment; and after passing verification, establish a secure channel connecting the first trusted execution environment and the second trusted execution environment.

Optionally, the encryption algorithm is determined by the first trusted execution environment and the second trusted execution environment through the secure channel.

Optionally, the sample alignment module is also configured to, in the first trusted execution environment, obtain corresponding first target sample attributes based on all first target sample identifiers included in the first target intersection; and use all first target sample identifiers and the corresponding first target sample attributes as the first sample alignment result.

Optionally, the apparatus further includes an output module. The output module is specifically configured to output all obtained first target sample attributes from the first trusted execution environment.

Optionally, the apparatus further includes a sending module. The sending module is specifically configured to, in the first trusted execution environment, after determining the first initial intersection of the at least one first sample identifier and the at least one second sample identifier and performing the shuffle processing on all first target sample identifiers in the first initial intersection to obtain the first target intersection, send the first target intersection to the second trusted execution environment through the first trusted execution environment, such that the second participant system, in the second trusted execution environment, obtains corresponding second target sample attributes based on all first target sample identifiers included in the first target intersection; and use all first target sample identifiers and the corresponding second target sample attributes as the second sample alignment result.

Optionally, a quantity of the at least one first sample identification is greater than a quantity of the at least one second sample identification.

Another aspect of embodiments of the present disclosure provides a computer device, including a memory, a processor and a computer program stored in the memory and executable on the processor, where when the processor executes the computer program, steps of above-mentioned method are implemented.

Another aspect of embodiments of the present disclosure provides a computer-readable storage medium, storing a computer program executable by a computer device, where when the computer program is executed on the computer device, the computer device is configured to execute steps of above-mentioned method.

Another aspect of embodiments of the present disclosure provides a computer program product. The computer program product includes a computer program stored on a computer-readable storage medium; the computer program includes program instructions; and when the program instructions are executed by a computer device, the computer device is configured to execute steps of above-mentioned method.

In embodiments of the present disclosure, the first participant system obtains at least one second sample identifier of the second participant system from the second trusted execution environment through the first trusted execution environment; in the first trusted execution environment, determines the first initial intersection of at least one first sample identifier and at least one second sample identifier, and performs the shuffle processing on all first target sample identifiers in the first initial intersection to obtain the first target intersection; and based on the first target intersection, determines the first sample alignment result. Since the sample alignment process in embodiments of the present disclosure is performed in the trusted execution environment, sample identity may be also ensured to be not leaked without using a hardware encryption machine. Meanwhile, the trusted execution environment may be highly versatile and flexibly customized for different methods for sample alignment according to different application scenarios to meet needs of different application scenarios.

### BRIEF DESCRIPTION OF THE DRAWINGS

In order to clearly illustrate the technical solutions in various embodiments of the present disclosure, accompanying drawings, which are required to be used in the description of disclosed embodiments, are briefly described hereinafter. Obviously, accompanying drawings in the following description are only certain embodiments of the present disclosure. For those skilled in the art, other accompanying drawings may be obtained based on these drawings without creative effort.

FIG. 1 illustrates a schematic of a system architecture in various embodiments of the present disclosure.

FIG. 2 illustrates a schematic flowchart of a method for sample alignment in various embodiments of the present disclosure.

FIG. 3 illustrates a schematic flowchart of another method for sample alignment in various embodiments of the present disclosure.

FIG. 4 illustrates a schematic flowchart of another method for sample alignment in various embodiments of the present disclosure.

FIG. 5 illustrates a schematic flowchart of another method for sample alignment in various embodiments of the present disclosure.

FIG. 6 illustrates a structural schematic of an apparatus for sample alignment in various embodiments of the present disclosure; and

FIG. 7 illustrates a structural schematic of a computer device in various embodiments of the present disclosure.

### DETAILED DESCRIPTION

To describe the objectives, technical solutions and beneficial effects of the present disclosure more clearly, the present disclosure is further described in detail below with reference to accompanying drawings and embodiments. It should be understood that specific embodiments described here are only configured to explain the present disclosure and not intended to limit the present disclosure.

To facilitate understanding, the terms in embodiments of the present disclosure are described below.

Trusted execution environment (TEE) is configured for digital rights management, mobile payments and sensitive data protection.

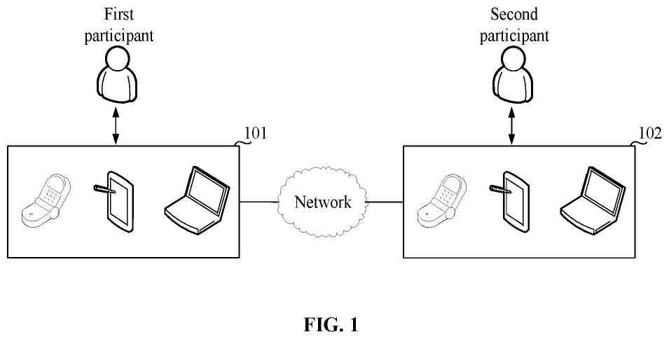

FIG. 1 illustrates a schematic of a system architecture in various embodiments of the present disclosure. The system architecture may at least include a first participant system 101 and a second participant system 102.

The first participant system 101 may be configured to perform a method for sample alignment by the first participant. The first participant system 101 may be a smart phone, a tablet computer, a notebook computer, a desktop computer, a server or the like, but may not be limited thereto. The first trusted execution environment may be deployed at the first participant system 101.

The second participant system 102 may be configured to perform the method for sample alignment by the second participant. The second participant system 102 may be a smartphone, a tablet computer, a notebook computer, a desktop computer, a server or the like, but may not be limited thereto. The second trusted execution environment may be deployed at the second participant system 102.

The first participant system 101 and the second participant system 102 may be directly connected through a wired or wireless manner, or the connection may be established through an intermediate server. The intermediate server may be an independent physical server; or a server cluster or a distributed system including multiple physical servers; or a cloud sever for providing basic cloud computing services including cloud service, cloud database, cloud computing, cloud functions, cloud storage, network service, cloud communication, middleware service, domain name service, security service, content delivery network (CDN), big data, artificial intelligence platform and the like.

The first participant system 101 may verify the security of the second trusted execution environment through the first trusted execution environment. The second participant system 102 may verify the security of the first trusted execution environment through the second trusted execution environment. After two parties pass the verification, a secure channel connecting the first trusted execution environment and the second trusted execution environment may be established.

The first trusted execution environment and the second trusted execution environment may determine an encryption algorithm through the secure channel. The encryption algorithm may be any one of Hash algorithm, MAC algorithm, HMAC algorithm (Hash-based message authentication code) and the like. Since the encryption algorithm is determined by the first trusted execution environment and the second trusted execution environment through the secure channel, manual negotiation may not be needed, which may reduce the risk of encryption algorithm leakage.

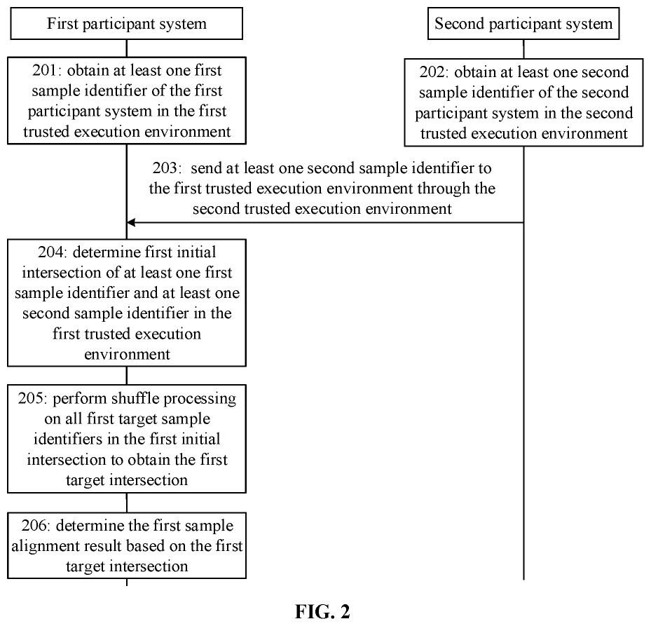

Based on the system architecture schematic shown in FIG. 1, embodiments of the present disclosure provide flow processes of the method for sample alignment. As shown in FIG. 2, the flow processes of such method may be interactively executed by the first participant system 101 and the second participant system 102 shown in FIG. 1 and may include following exemplary steps.

At S201, in the first trusted execution environment, at least one first sample identifier of the first participant system may be obtained.

Optionally, the first sample identifier may be the first original sample identifier or may be an identifier obtained by the first participant system in the first trusted execution environment through encrypting the first original sample identifier using the encryption algorithm.

The first participant system may simultaneously add the first sample attributes corresponding to all first sample identifiers to the first trusted execution environment, where the sample attributes may be sample characteristics.

At S202, in the second trusted execution environment, at least one second sample identifier of the second participant system may be obtained.

Optionally, the second sample identifier may be the second original sample identifier or may be an identifier obtained by the second participant system in the second trusted execution environment through encrypting the second original sample identifier using the encryption algorithm.

The second participant system may simultaneously add the second sample attributes corresponding to all second sample identifiers to the second trusted execution environment.

S201 and S202 may not be executed in a particular order.

In an optional implementation manner, after the first participant system encrypts the first original sample identifier to obtain the first sample identifier in the first trusted execution environment, the first participant system may perform shuffle processing on at least one first sample identifier in the first trusted execution environment and output at least one first sample identifier shuffled and corresponding first sample attribute to a third-party system.

After the second participant system encrypts the second original sample identifier in the second trusted execution environment to obtain the second sample identifier, the second participant system may perform shuffle processing on at least one second sample identifier in the second trusted execution environment and output at least one second sample identifier shuffled and corresponding second sample attribute to a third-party system.

The third-party system may determine the first target intersection of at least one first sample identifier and at least one second sample identifier; and based on the first target intersection, the sample alignment result may be determined.

The encryption algorithm used in the first trusted execution environment may be same as the encryption algorithm used in the second trusted execution environment. Therefore, same original sample identifiers may be encrypted respectively, and the first sample identifiers and the second sample identifiers which are obtained may be same, which may ensure basic premise of sample alignment operation. Meanwhile, the first sample identifier obtained by encryption may be outputted to the first participant system, and the first participant system cannot reversely decipher the correspondence between the first sample identifier and the first original sample identifier. The encrypted second sample identifier may be outputted to the second participant system, and the second participant system cannot reversely decipher the correspondence between the second sample identifier and the second original sample identifier. Therefore, the sample alignment may be achieved while ensuring that the original sample identifier is not leaked.

At S203, the second participant system may send at least one second sample identifier to the first trusted execution environment through the second trusted execution environment.

Specifically, the second participant system may, via the secure channel, send at least one second sample identifier and corresponding second sample attribute to the first trusted execution environment through the second trusted execution environment.

At least one second sample identifier of the second participant system may be stored in the first trusted execution environment. Meanwhile, the first participant system may not directly obtain at least one second sample identifier of the second participant system from the first trusted execution environment.

At S204, the first participant system may determine the first initial intersection of at least one first sample identifier and at least one second sample identifier in the first trusted execution environment.

At S205, in the first trusted execution environment, the first participant system may perform shuffle processing on all first target sample identifiers in the first initial intersection to obtain the first target intersection.

For example, the first trusted execution environment may include three first sample identifiers, and each first sample identifier may correspond to one first sample attribute. Three first sample identifiers may be identifier 1, identifier 2 and identifier 3 respectively; and correspondingly, the first sample attributes may be attribute A, attribute B and attribute C respectively, which are specifically shown in Table 1.

Meanwhile, the first participant system may obtain four second sample identifiers through the first trusted execution environment, and each second sample identifier may correspond to one second sample attribute. In the first trusted execution environment, four second sample identifiers may be identifier 1, identifier 2, identifier 4 and identifier 3, respectively; and correspondingly, the second sample attributes may be attribute D, attribute E, attribute F and attribute G respectively, which are specifically shown in Table 2.

TABLE 1

| First sample identifier | First sample attribute |
|---|---|
| Identifier 1 | Attribute A |
| Identifier 2 | Attribute B |
| Identifier 3 | Attribute C |

TABLE 2

| Second sample identifier | Second sample attribute |
|---|---|
| Identifier 1 | Attribute D |
| Identifier 2 | Attribute E |
| Identifier 4 | Attribute F |
| Identifier 3 | Attribute G |

The intersection of three first sample identifiers in Table 1 and four second sample identifiers in Table 2 may be determined as the first initial intersection. At this point, the first target intersection may include identifier 1, identifier 2, and identifier 3, as shown in Table 3.

TABLE 3
First target sample identifier

Identifier 1
Identifier 2
Identifier 3

Shuffle processing may be performed on three first target sample identifiers in Table 3, and the result is shown in Table 4.

TABLE 4
First target sample identifier

Identifier 3
Identifier 1
Identifier 2

In embodiments of the present disclosure, in the first trusted execution environment, the first participant system may perform shuffle processing on all first target sample identifiers in the first initial intersection, thereby enhancing data confidentiality.

At S206, in the first trusted execution environment, the first participant system may determine the first sample alignment result based on the first target intersection.

Optionally, in the first trusted execution environment, the first participant system may obtain corresponding first target sample attributes based on all first target sample identifiers included in the first target intersection; and use all first target sample identifiers and corresponding first target sample attribute as the first sample alignment result.

The first participant system may output all obtained first target sample attributes from the first trusted execution environment and apply all obtained first target sample attributes to other environments to perform subsequent operations.

For example, the first target intersection in the first trusted execution environment is shown in Table 4; and according to three first target sample identifiers in Table 4, corresponding first target sample attributes may be determined by looking up Table 1, which are attribute C, attribute A, and attribute B respectively, as shown in Table 5. All first target sample identifiers in Table 4 and corresponding first target sample attribute in Table 5 may be used as the first sample alignment result, as shown in Table 6. Three first target sample attributes in Table 5 may be outputted from the first trusted execution environment, and all obtained first target sample attributes may be applied to other environments to perform subsequent operations.

TABLE 5
First target sample attribute

Attribute C
Attribute A
Attribute B

TABLE 6

| First target sample identifier | First target sample attribute |
|---|---|
| Identifier 3 | Attribute C |
| Identifier 1 | Attribute A |
| Identifier 2 | Attribute B |

In embodiments of the present disclosure, the first participant system may obtain at least one second sample identifier of the second participant system from the second trusted execution environment through the first trusted execution environment, and in the first trusted execution environment, determine the first initial intersection of at least one first sample identifier and at least one second sample identifier, and perform shuffle processing on all first target sample identifiers in the first initial intersection to obtain the first target intersection. Based on the first target intersection, the first sample alignment result may be determined. Since the sample alignment process in embodiments of the present disclosure is performed in the trusted execution environment, sample identity may be also ensured to be not leaked without using a hardware encryption machine. Meanwhile, the trusted execution environment may be highly versatile and flexibly customized for different methods for sample alignment according to different application scenarios to meet needs of different application scenarios.

Optionally, for the second participant system, embodiments of the present disclosure provide at least two following implementation manners for obtaining the sample alignment result.

In an optional implementation manner, the second participant system may obtain at least one first sample identifier of the first participant system from the first trusted execution environment through the second trusted execution environment, determine the second initial intersection of at least one second sample identifier and at least one first sample identifier in the second trusted execution environment, perform shuffle processing on all second target sample identifiers in the second initial intersection to obtain the second target intersection, and based on the second target intersection, determine the second sample alignment result.

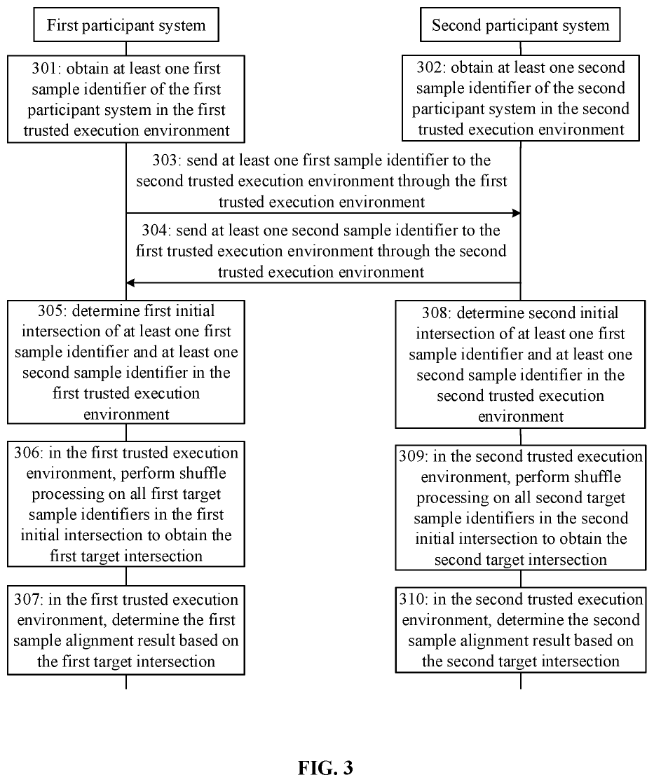

Specifically, based on the system architecture schematic shown in FIG. 1, embodiments of the present disclosure provide flow processes of a method for sample alignment. As shown in FIG. 3, the flow processes of such method may be interactively executed by the first participant system 101 and the second participant system 102 shown in FIG. 1 and include following exemplary steps.

At S301, in the first trusted execution environment, at least one first sample identifier of the first participant system may be obtained.

At S302, in the second trusted execution environment, at least one second sample identifier of the second participant system may be obtained.

At S303, the first participant system may send at least one first sample identifier to the second trusted execution environment through the first trusted execution environment.

Specifically, the first participant system may, via the secure channel, send at least one first sample identifier and corresponding first sample attribute to the second trusted execution environment through the first trusted execution environment.

At least one first sample identifier of the first participant system may be stored in the second trusted execution environment. Meanwhile, the second participant system cannot directly obtain at least one first sample identifier of the first participant system from the second trusted execution environment.

At S304, the second participant system may send at least one second sample identifier to the first trusted execution environment through the second trusted execution environment.

Specifically, the second participant system may, via the secure channel, send at least one second sample identifier and corresponding second sample attribute to the first trusted execution environment through the second trusted execution environment.

S301 and S302 may not be executed in a particular order. S303 and S304 may not be executed in a particular order.

At S305, in the first trusted execution environment, the first participant system may determine the first initial intersection of at least one first sample identifier and at least one second sample identifier.

At S306, in the first trusted execution environment, the first participant system may perform shuffle processing on all first target sample identifiers in the first initial intersection to obtain the first target intersection.

At S307, in the first trusted execution environment, the first participant system may determine the first sample alignment result based on the first target intersection.

At S308, in the second trusted execution environment, the second participant system may determine the second initial intersection of at least one second sample identifier and at least one first sample identifier.

At S309, in the second trusted execution environment, the second participant system may perform shuffle processing on all second target sample identifiers in the second initial intersection to obtain the second target intersection.

For example, the second trusted execution environment may include four second sample identifiers, and each second sample identifier may correspond to one second sample attribute. Four second sample identifiers may be identifier 1, identifier 2, identifier 4 and identifier 3. Corresponding second sample attributes may be attribute D, attribute E, attribute F and attribute G respectively, which are specifically shown in Table 2.

Meanwhile, the second participant system may obtain three first sample identifiers through the second trusted execution environment, and each first sample identifier may correspond to one first sample attribute. In the second trusted execution environment, the three first sample identifiers may be identifier 1, identifier 2 and identifier 3 respectively. Corresponding first sample attributes may be attribute A, attribute B and attribute C respectively, which are specifically shown in Table 1.

The intersection of four second sample identifiers in Table 2 and three first sample identifiers in Table 1 may be determined as the second initial intersection. At this point, the second initial intersection may include identifier 1, identifier 2, and identifier 3, as shown in Table 7.

TABLE 7
Second target sample identifier

Identifier 1
Identifier 2
Identifier 3

Shuffle processing may be performed on three second target sample identifiers in Table 7, and the result is shown in Table 8.

TABLE 8
Second target sample identifier

Identifier 1
Identifier 3
Identifier 2

In embodiments of the present disclosure, in the second trusted execution environment, the second participant system may perform shuffle processing on all second target sample identifiers in the second initial intersection, thereby enhancing data confidentiality.

At S310, in the second trusted execution environment, the second participant system may determine the second sample alignment result based on the second target intersection.

Optionally, in the second trusted execution environment, the second participant system may obtain corresponding second target sample attributes based on all second target sample identifiers included in the second target intersection; and use all second target sample identifiers and corresponding second target sample attributes as the second sample alignment result. The second participant system may output all obtained second target sample attributes from the second trusted execution environment and apply all obtained second target sample attributes to other environments to perform subsequent operations.

For example, the second target intersection in the second trusted execution environment is shown in Table 8. According to three second target sample identifiers in Table 8, corresponding second target sample attributes may be determined by looking up Table 2, which are attribute D, attribute G, and attribute E respectively as shown in Table 9. All second target sample identifiers in Table 8 and corresponding second target sample attributes in Table 9 may be used as the second sample alignment result as shown in Table 10. Three second target sample attributes in Table 9 may be outputted from the second trusted execution environment, and all obtained second target sample attributes may be applied to other environments to perform subsequent operations.

TABLE 9
Second target sample attribute

Attribute D
Attribute G
Attribute E

TABLE 10

| Second target sample identifier | Second target sample attribute |
|---|---|
| Identifier 1 | Attribute D |
| Identifier 3 | Attribute G |
| Identifier 2 | Attribute E |

Since the sample alignment process in embodiments of the present disclosure is performed in the trusted execution environment, the sample identifier may be ensured to be not leaked. Meanwhile, the trusted execution environment may be highly versatile and flexibly customized for different methods for sample alignment according to different application scenarios to meet needs of different application scenarios.

In another optional implementation manner, after the first participant system determines the first initial intersection of at least one first sample identifier and at least one second sample identifier in the first trusted execution environment and performs shuffle processing on all first target sample identifiers in the first initial intersection to obtain the first target intersection, the first participant system may send the first target intersection to the second trusted execution environment through the first trusted execution environment. The second participant system may obtain corresponding second target sample attributes based on all first target sample identifiers included in the first target intersection through the second trusted execution environment; and all first target sample identifiers and corresponding second target sample attributes may be used as the second sample alignment result.

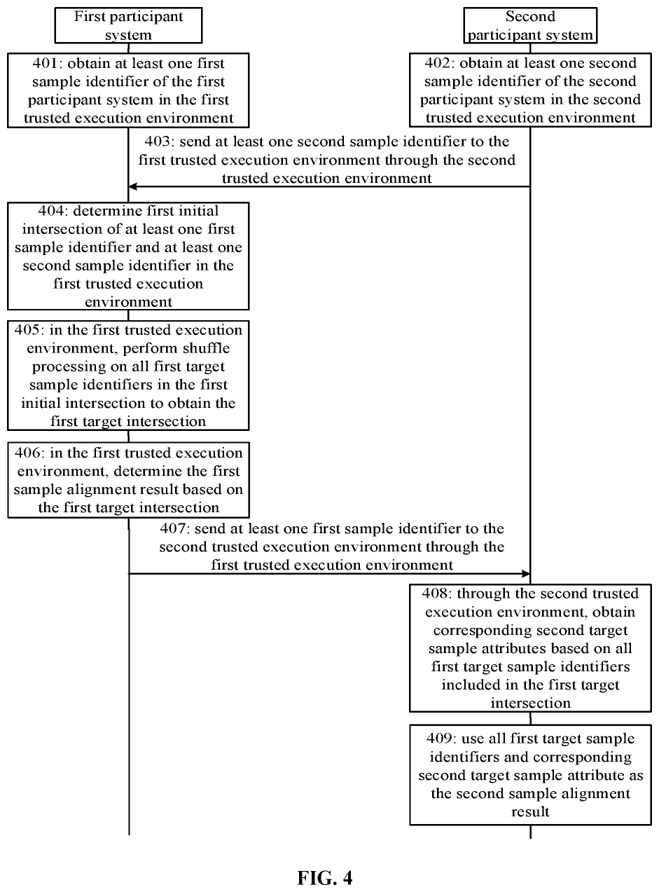

Specifically, based on the system architecture schematic shown in FIG. 1, embodiments of the present disclosure provide flow processes of another method for sample alignment. As shown in FIG. 4, the flow processes of such method may be interactively executed by the first participant system 101 and the second participant system 102 shown in FIG. 1 and include following exemplary steps.

At S401, in the first trusted execution environment, at least one first sample identifier of the first participant system may be obtained.

At S402, in the second trusted execution environment, at least one second sample identifier of the second participant system may be obtained.

S401 and S402 may not be executed in a particular order.

At S403, the second participant system may send at least one second sample identifier to the first trusted execution environment through the second trusted execution environment.

Specifically, the second participant system may, via the secure channel, send at least one second sample identifier to the first trusted execution environment through the second trusted execution environment.

At S404, in the first trusted execution environment, the first participant system may determine the first initial intersection of at least one first sample identifier and at least one second sample identifier.

At S405, in the first trusted execution environment, the first participant system may perform shuffle processing on all first target sample identifiers in the first initial intersection to obtain the first target intersection.

At S406, in the first trusted execution environment, the first participant system may determine the first sample alignment result based on the first target intersection.

At S407, the first participant system may send the first target intersection to the second trusted execution environment through the first trusted execution environment.

Specifically, the first participant system may, via the secure channel, send the first target intersection to the second trusted execution environment through the first trusted execution environment.

At S408, the second participant system may obtain corresponding second target sample attributes based on all first target sample identifiers included in the first target intersection through the second trusted execution environment.

Specifically, the first target intersection may be stored in the second trusted execution environment, and the second participant system may not directly obtain the first target intersection from the first trusted execution environment.

For example, the first participant system may perform shuffle processing on all first target sample identifiers in the first initial intersection to obtain the first target intersection as shown in Table 4. The first participant system may send three first target sample identifiers shown in Table 4 to the second trusted execution environment through the first trusted execution environment. By looking up Table 2 through three first target sample identifiers shown in Table 4, corresponding second target sample attributes may be obtained, which are attribute G, attribute D and attribute E respectively as shown in Table 11.

TABLE 11
Second target sample attribute

attribute G
attribute D
attribute E

At S409, the second participant system may use all first target sample identifiers and corresponding second target sample attribute as the second sample alignment result.

Specifically, the second participant system may output obtained second target sample attributes from the second trusted execution environment and apply obtained second target sample attributes to other environments to perform subsequent operations.

For example, all first target sample identifiers in Table 4 and corresponding second target sample attribute in Table 11 may be used as the second sample alignment result, as shown in Table 12. The three second target sample attributes in Table 11 may be outputted from the second trusted execution environment, and all obtained second target sample attributes may be applied to other environments to perform subsequent operations.

TABLE 12

| First target sample identifier | Second target sample attritube |
|---|---|
| Identifier 3 | Attribute G |
| Identifier 1 | Attribute D |
| Identifier 2 | Attribute E |

For selecting and generating the trusted execution environment for the first target intersection, embodiments of the present disclosure provide at least following implementation manners.

For manner one, the trusted execution environment of any participant may be randomly selected to perform the intersection of at least one first sample identifier and at least one second sample identifier to obtain the first initial intersection; shuffle processing may be performed on all first target sample identifiers in the first initial intersection to obtain the first target intersection; and the first target intersection may be then sent to the trusted execution environment of another participant.

For manner two, the quantity of at least one first sample identifier and the quantity of at least one second sample identifier may be compared; if the quantity of at least one first sample identifier is less than the quantity of at least one second sample identifier, the second trusted execution environment may be selected to perform the intersection of at least one first sample identifier and at least one second sample identifier to obtain the first initial intersection; otherwise, the first trusted execution environment may be selected to perform the intersection of at least one first sample identifier and the at least one second sample identifier to obtain the first initial intersection.

In embodiments of the present disclosure, the trusted execution environment of the participant system with more sample identifiers may be selected to perform sample intersection, and the participant system with fewer sample identifiers may send the sample identifiers to the trusted execution environment of another participant system through the trusted execution environment, which may effectively save time of sending the sample identifiers.

Since the sample alignment process in embodiments of the present disclosure is performed in the trusted execution environment, the sample identifier may be ensured to be not leaked. Meanwhile, the trusted execution environment may be highly versatile and flexibly customized for different methods for sample alignment according to different application scenarios to meet needs of different application scenarios.

Furthermore, in the trusted execution environment, the first sample identifier and the second sample identifier may not need to be encrypted. Therefore, the time used for sample alignment in the trusted execution environment may be saved, and sample alignment performance may be improved. Meanwhile, the second participant system may only send the second sample identifiers and may not send the second sample attributes to the first trusted execution environment through the second trusted execution environment, such that the time of sending sample data may be effectively saved.

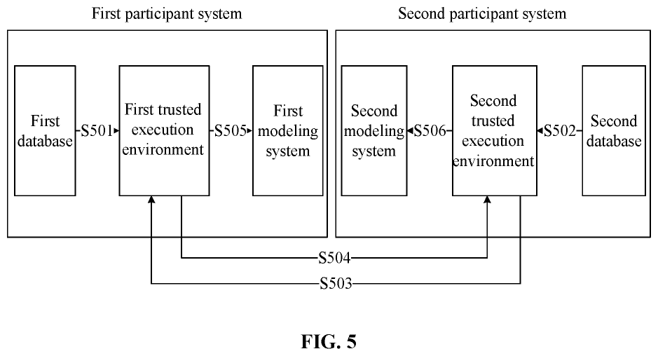

In order to better explain embodiments of the present disclosure, a method for sample alignment provided by embodiments of the present disclosure is described below in conjunction with specific implementation scenarios. As shown in FIG. 5, the first participant system may include the first database, the first trusted execution environment and the first modeling system; and the first database may store at least one first original sample identifier and a corresponding first sample attribute. The second participant system may include the second database, the second trusted execution environment and the second modeling system; and the second database may store at least one second original sample identifier and a corresponding second sample attribute. Meanwhile, the quantity of sample identifiers in the first database may be greater than the quantity of sample identifiers in the second database.

At S501, the first participant system may send at least one first original sample identifier and the corresponding first sample attribute in the first database to the first trusted execution environment.

In the first trusted execution environment, the first participant system may encrypt the first original sample identifier using the encryption algorithm to obtain the first sample identifier.

At S502, the second participant system may send at least one second sample identifier and the corresponding first sample attribute in the second database to the first trusted execution environment.

In the second trusted execution environment, the second participant system may encrypt the second original sample identifier using the encryption algorithm to obtain the second sample identifier.

At S503, the second participant system may send at least one second sample identifier to the first trusted execution environment through the second trusted execution environment.

In the first trusted execution environment, the first participant system may determine the first initial intersection of at least one first sample identifier and at least one second sample identifier and perform shuffle processing on all first target sample identifiers in the first initial intersection to obtain the first target intersection.

In the first trusted execution environment, the first participant system may obtain corresponding first target sample attributes based on all first target sample identifiers included in the first target intersection; and use all first target sample identifiers and corresponding first target sample attribute as the first sample alignment result. The first participant system may output all obtained first target sample attributes from the first trusted execution environment and apply all obtained first target sample attributes to other environments to perform subsequent operations.

At S504, the first participant system may send the first target intersection to the second trusted execution environment through the first trusted execution environment.

In the second trusted execution environment, the second participant system may obtain corresponding second target sample attributes based on all first target sample identifiers included in the first target intersection; and use all first target sample identifiers and corresponding second target sample attribute as the second sample alignment result. The second participant system may output all obtained second target sample attributes from the second trusted execution environment and apply all obtained second target sample attributes to other environments to perform subsequent operations.

At S505, the first participant system may input all first target sample attributes outputted by the first trusted execution environment into the first modeling system to perform subsequent modeling applications.

At S506, the second participant system may input all second target sample attributes outputted by the second trusted execution environment into the second modeling system to perform subsequent modeling applications.

In embodiments of the present disclosure, since the sample alignment process in embodiments of the present disclosure is performed in the trusted execution environment, the sample identifier may be ensured to be not leaked. In addition, the trusted execution environment may be highly versatile and flexibly customized for different methods for sample alignment according to different application scenarios to meet needs of different application scenarios. In the first trusted execution environment, the first participant system may perform shuffle processing on all first target sample identifiers in the first initial intersection, thus enhancing data confidentiality.

The trusted execution environment of the participant system with more sample identifiers may be selected to perform sample intersection, and the participant system with fewer sample identifiers may send the sample identifiers to the trusted execution environment of another participant system through the trusted execution environment, which may effectively save time of sending the sample identifiers.

Based on the same technical concept, embodiments of the present disclosure provide an apparatus for sample alignment. The first trusted execution environment may be deployed at the apparatus for sample alignment. As shown in FIG. 6, the apparatus 600 may include:
an obtaining module 601, configured to obtain at least one first sample identifier of the first participant system in the first trusted execution environment; and further obtain at least one second sample identifier of the second participant system from the second trusted execution environment through the first trusted execution environment, where the second trusted execution environment may be deployed at the second participant system; and
a sample alignment module 602, configured to determine the first initial intersection of the at least one first sample identifier and the at least one second sample identifier in the first trusted execution environment, and perform shuffle processing on all first target sample identifiers in the first initial intersection to obtain the first target intersection; and further configured to determine the first sample alignment result based on the first target intersection.

Optionally, the at least one first sample identifier may be obtained by the first participant system in the first trusted execution environment through encrypting the first original sample identifier using the encryption algorithm; and the at least one second sample identifier may be obtained by the second participant system in the second trusted execution environment through encrypting the second original sample identifier using the encryption algorithm.

Optionally, the apparatus 600 may further include a verification module 603. The verification module 603 may be specifically configured to, before obtaining at least one first sample identifier of the first participant system in the first trusted execution environment, verify the security of the second trusted execution environment through the first trusted execution environment, and after the verification is passed, establish the secure channel connecting the first trusted execution environment and the second trusted execution environment.

Optionally, the encryption algorithm may be determined by the first trusted execution environment and the second trusted execution environment through the secure channel.

Optionally, the sample alignment module 602 may be further configured to, in the first trusted execution environment, obtain corresponding first target sample attributes based on all first target sample identifiers included in the first target intersection; and use all first target sample identifiers and corresponding first target sample attribute as the first sample alignment result.

Optionally, the apparatus 600 may further include an output module 604. The output module 604 may be specifically configured to output all obtained first target sample attributes from the first trusted execution environment.

Optionally, the apparatus 600 may further include a sending module 605. The sending module 605 may be specifically configured to, after determining the first initial intersection of the at least one first sample identifier and the at least one second sample identifier in the first trusted execution environment and performing shuffle processing on all first target sample identifiers in the first initial intersection to obtain the first target intersection, send the first target intersection to the second trusted execution environment through the first trusted execution environment, such that the second participant system may, in the second trusted execution environment, obtain corresponding second target sample attribute based on all first target sample identifiers included in the first target intersection; and use all first target sample identifiers and corresponding second target sample attribute as the second sample alignment result.

Optionally, the quantity of the at least one first sample identifier may be greater than the quantity of the at least one second sample identifier.

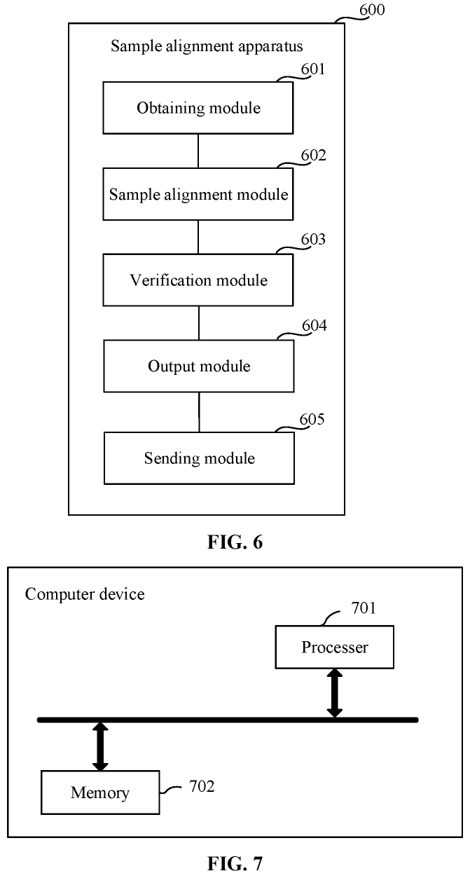

Based on the same technical concept, embodiments of the present disclosure provide a computer device. The computer device may be a terminal or a server. As shown in FIG. 7, the computer device may include at least one processor 701, and one memory 702 connected to at least one processor. Specific connection medium between the processor 701 and the memory 702 may be not limited in embodiments of the present disclosure. In FIG. 7, the processor 701 and the memory 702 may be connected through, for example, a bus. The bus may be divided into an address bus, a data bus, a control bus and the like.

In embodiments of the present disclosure, the memory 702 may store instructions that can be executed by at least one processor 701. At least one processor 701 may perform the steps included in above-mentioned method for sample alignment by executing the instructions stored in the memory 702.

The processor 701 may be the control center of the computer device, use various interfaces and lines to connect various parts of the computer device, and perform sample alignment by running or executing the instructions stored in the memory 702 and calling data stored in the memory 702. Optionally, the processor 701 may include one or more processing units and integrate an application processor and a modem processor, where the application processor may mainly handle operating system, user interface, application program and the like, and the modem processor may mainly handle wireless communication. It can be understood that above-mentioned modem processor may not be integrated into the processor 701. In some embodiments, the processor 701 and the memory 702 may be implemented on a same chip; and in some other embodiments, may also be implemented on separate chips.

The processor 701 may be a general processor, such as a central processing unit (CPU), a digital signal processor, an application specific integrated circuit (ASIC), a field programmable gate array or another programmable logic device, a discrete gate, a transistor logic device or a discrete hardware component, which may implement or execute each method, step and logical block diagram disclosed in embodiments of the present disclosure. The general-purpose processor may be a microprocessor, a conventional processor or the like. The steps of above-mentioned method disclosed in conjunction with embodiments of the present disclosure may be directly executed by a hardware processor or may be executed by a combination of hardware and software modules in the processor.

As a non-volatile computer-readable storage medium, the memory 702 may be configured to store non-volatile software programs, non-volatile computer executable programs and modules. The memory 702 may include at least one type of storage medium, for example, may include flash memory, hard disk, multimedia card, card-type memory, random access memory (RAM), static random access memory (SRAM), programmable read only memory (PROM), read only memory (ROM), electrically erasable programmable read-only memory (EEPROM), magnetic memory, magnetic disc, optical disc or the like. The memory 702 may be, but may not be limited to, any other medium that may be configured to carry or store desired program code in the form of instructions or data structures and may be accessed by the computer. The memory 702 in embodiments of the present disclosure may also be a circuit or any other device which is capable of realizing storage function and configured to store program instructions and/or data.

Based on the same inventive concept, embodiments of the present disclosure provide a computer-readable storage medium that may store a computer program capable of being executed by the computer device. When the program is executed on the computer device, the computer device may be configured to perform the steps of above-mentioned method for sample alignment.

Based on the same inventive concept, embodiments of the present disclosure provide a computer program product. The computer program product may include a computer program stored on the computer-readable storage medium. The computer program may include program instructions. When the program instructions are executed by the computer, the computer may be configured to perform the steps of above-mentioned method for sample alignment.

Those skilled in the art should understand that embodiments of the present disclosure may be provided as methods, systems, or computer program products. Accordingly, the present disclosure may take the form of an entirely hardware embodiment, an entirely software embodiment, or an embodiment that combines software and hardware aspects. Furthermore, the present disclosure may take the form of a computer program product embodied on one or more computer-usable storage media (may include, but may not be limited to, disk storage, CD-ROM, optical storage and the like) including computer-usable program code therein.

The present disclosure is described with reference to flowcharts and/or block diagrams of methods, devices (systems), and computer program products according to various embodiments of the present disclosure. It should be understood that each process and/or block in the flowcharts and/or block diagrams, and the combination of processes and/or blocks in the flowcharts and/or block diagrams may be implemented by computer program instructions. Such computer program instructions may be provided to the processor of a general-purpose computer, a special-purpose computer, an embedded processor, or other programmable data processing apparatus, such that the instructions executed by the processor of the computer or other programmable data processing apparatus may implement the functions specified in one or more processes in the flowcharts and/or one or more blocks in the block diagrams.

Such computer program instructions may also be stored in a computer-readable memory that can direct a computer or other programmable data processing apparatus to work in a specific manner, such that the instructions stored in the computer-readable memory may produce a manufactured product including the instruction device. The instruction device may implement the functions specified in one or more processes in the flowcharts and/or one or more blocks in the block diagrams.

Such computer program instructions may also be loaded on a computer or other programmable data processing apparatus, such that a series of operation steps may be executed on the computer or other programmable apparatus to produce computer-implemented processing. Therefore, the instructions executed by the processor of the computer or other programmable data processing apparatus may implement the functions specified in one or more processes in the flowcharts and/or one or more blocks in the block diagrams.

Obviously, those skilled in the art may make various changes and modifications to the present disclosure without departing from the spirit and scope of the present disclosure. In such way, if these modifications and variations of the present disclosure fall within the scope of the claims of the present disclosure and their equivalent technologies, the present disclosure may also be intended to include these modifications and variations.

1. A method for sample alignment, applied to a first participant system, wherein a first trusted execution environment is deployed at the first participant system, the method comprising:
in the first trusted execution environment, obtaining at least one first sample identifier of the first participant system;
through the first trusted execution environment, obtaining at least one second sample identifier of the second participant system from a second trusted execution environment, wherein the second trusted execution environment is deployed at the second participant system;
in the first trusted execution environment, determining a first initial intersection of the at least one first sample identifier and the at least one second sample identifier and performing a shuffle processing on all first target sample identifiers in the first initial intersection to obtain a first target intersection; and
based on the first target intersection, determining a first sample alignment result.

2. The method according to claim 1, wherein:
the at least one first sample identifier is obtained in the first trusted execution environment by the first participant system through encrypting a first original sample identifier using an encryption algorithm; and
the at least one second sample identifier is obtained in the second trusted execution environment by the second participant system through encrypting a second original sample identifier using the encryption algorithm.

3. The method according to claim 2, in the first trusted execution environment, before obtaining the at least one first sample identifier of the first participant system, further including:
verifying security of the second trusted execution environment through the first trusted execution environment; and after the security of the second trusted execution environment is verified, establishing a secure channel connecting the first trusted execution environment and the second trusted execution environment.

4. The method according to claim 3, wherein:
the encryption algorithm is determined by the first trusted execution environment and the second trusted execution environment through the secure channel.

5. The method according to claim 1, wherein based on the first target intersection, determining the first sample alignment result includes:
in the first trusted execution environment, obtaining corresponding first target sample attributes based on all first target sample identifiers included in the first target intersection; and using all first target sample identifiers and the corresponding first target sample attributes as the first sample alignment result.

6. The method according to claim 5, further including:
outputting the corresponding first target sample attributes from the first trusted execution environment.

7. The method according to claim 1, in the first trusted execution environment, after determining the first initial intersection of the at least one first sample identifier and the at least one second sample identifier and performing the shuffle processing on all first target sample identifiers in the first initial intersection to obtain the first target intersection, further including:
sending the first target intersection to the second trusted execution environment through the first trusted execution environment, such that the second participant system, in the second trusted execution environment, obtains corresponding second target sample attributes based on all first target sample identifiers included in the first target intersection; and using all first target sample identifiers and the corresponding second target sample attributes as the second sample alignment result.

8. The method according to claim 1, wherein:
a quantity of the at least one first sample identification is greater than a quantity of the at least one second sample identification.

9. (canceled)

10. A computer device, comprising:
a memory, a processor and a computer program stored in the memory and executable on the processor, wherein when the processor executes the computer program, a method for sample alignment is implemented, wherein the method is applied to a first participant system, and a first trusted execution environment is deployed at the first participant system, the method including:
in the first trusted execution environment, obtaining at least one first sample identifier of the first participant system;
through the first trusted execution environment, obtaining at least one second sample identifier of the second participant system from a second trusted execution environment, wherein the second trusted execution environment is deployed at the second participant system;
in the first trusted execution environment, determining a first initial intersection of the at least one first sample identifier and the at least one second sample identifier and performing a shuffle processing on all first target sample identifiers in the first initial intersection to obtain a first target intersection; and
based on the first target intersection, determining a first sample alignment result.

11. A non-transitory computer-readable storage medium, storing a computer program executable by a computer device, wherein when the computer program is executed a computer device, a method for sample alignment is implemented, wherein the method is applied to a first participant system, and a first trusted execution environment is deployed at the first participant system, the method including:
in the first trusted execution environment, obtaining at least one first sample identifier of the first participant system;
through the first trusted execution environment, obtaining at least one second sample identifier of the second participant system from a second trusted execution environment, wherein the second trusted execution environment is deployed at the second participant system;
in the first trusted execution environment, determining a first initial intersection of the at least one first sample identifier and the at least one second sample identifier and performing a shuffle processing on all first target sample identifiers in the first initial intersection to obtain a first target intersection; and
based on the first target intersection, determining a first sample alignment result.

12. A computer program product, wherein:
the computer program product includes a computer program stored on a computer-readable storage medium; the computer program includes program instructions; and when the program instructions are executed by a computer device, the computer device is configured to perform steps of the method according to claim 1 the corresponding first target sample attributes.

13. The computer device according to claim 10, wherein:
the at least one first sample identifier is obtained in the first trusted execution environment by the first participant system through encrypting a first original sample identifier using an encryption algorithm; and
the at least one second sample identifier is obtained in the second trusted execution environment by the second participant system through encrypting a second original sample identifier using the encryption algorithm.

14. The computer device according to claim 11, wherein in the first trusted execution environment, before obtaining the at least one first sample identifier of the first participant system, the processor is further configured to:
verify security of the second trusted execution environment through the first trusted execution environment; and after the security of the second trusted execution environment is verified, establish a secure channel connecting the first trusted execution environment and the second trusted execution environment.

15. The computer device according to claim 12, wherein:
the encryption algorithm is determined by the first trusted execution environment and the second trusted execution environment through the secure channel.

16. The computer device according to claim 10, wherein based on the first target intersection, determining the first sample alignment result includes:
in the first trusted execution environment, obtaining corresponding first target sample attributes based on all first target sample identifiers included in the first target intersection; and using all first target sample identifiers and the corresponding first target sample attributes as the first sample alignment result.

17. The computer device according to claim 14, wherein the processor is further configured to:
output the corresponding first target sample attributes from the first trusted execution environment.

18. The computer device according to claim 14, wherein in the first trusted execution environment, after determining the first initial intersection of the at least one first sample identifier and the at least one second sample identifier and performing the shuffle processing on all first target sample identifiers in the first initial intersection to obtain the first target intersection, the processor is further configured to:
send the first target intersection to the second trusted execution environment through the first trusted execution environment, such that the second participant system, in the second trusted execution environment, obtains corresponding second target sample attributes based on all first target sample identifiers included in the first target intersection; and use all first target sample identifiers and the corresponding second target sample attributes as the second sample alignment result.

19. The computer device according to claim 10, wherein:
a quantity of the at least one first sample identification is greater than a quantity of the at least one second sample identification.
